(19) United States
(12) Patent Application Publication
(10) Pub. No.: US 2023/0143769 A1
(43) Pub. Date: May 11, 2023

(54) SYSTEMS AND METHODS FOR AUTOMATICALLY DETERMINING A SPATIAL IMPACT ZONE OF AN EVENT OCCURRING IN REAL-TIME

(71) Applicant: Factal, Inc., Seattle, WA (US)

(72) Inventors: Cory Bergman, Mercer Island, WA (US); Benjamin Tesch, Seattle, WA (US)

(21) Appl. No.: 17/524,571

(22) Filed: Nov. 11, 2021

(51) Int. Cl. G06N 20/00

(52) U.S. Cl. CPC G06N 20/00; G06F 40/20

(57) ABSTRACT

Systems and methods for automatically determining a spatial impact zone of an event occurring in real-time are disclosed. Feature data gathered from electronic updates of an event is fed to a machine learning model that estimates and outputs the current spatial impact zone of an event in real-time. The machine learning model may be pre-trained with feature data of past events and corresponding data describing actual impact zones of past events. The current spatial impact zone may be used to determine which assets near the event are likely to be affected. Data describing the actual spatial impact zone, coupled with the corresponding feature data, is used to retrain the machine learning model on a batch basis. Data describing the actual spatial impact zone at a time of the output may be used to adjust the output of the machine learning model.

### TECHNICAL FIELD

The technical field relates to the automatic determination of a spatial impact zone of an event occurring in real-time.

### BRIEF SUMMARY

The present disclosure teaches a computerized method for estimating a current spatial impact zone of an event in real-time that may be summarized as including: electronically gathering, by at least one computer processor, feature data from electronic updates of the event; electronically feeding, by at least one computer processor, the feature data to a machine learning model, wherein: the machine learning model estimates in real-time the current spatial impact zone of the event based on the feature data; and the machine learning model outputs in real-time data describing the estimated current spatial impact zone of the event; electronically receiving, by at least one computer processor, data describing an actual spatial impact zone of the event as the event is occurring; electronically saving, by at least one computer processor, the data describing the actual spatial impact zone with the feature data; and electronically retraining, by at least one computer processor, the machine learning model on a batch basis with the data describing the actual spatial impact zone and the feature data.

According to some embodiments, the computerized method may further include electronically determining, by at least one computer processor, a probability that an asset is affected by the event based on the data describing the estimated current spatial impact zone of the event.

According to some embodiments, the computerized method may further include electronically determining, by at least one computer processor, whether to adjust output of the machine learning model, which represents the data describing the estimated current spatial impact zone of the event, based on whether the data describing the actual spatial impact zone at a time of the output is different from the data describing the estimated current spatial impact zone of the event.

According to some embodiments, the electronic updates of the event may at least include underlying data and written descriptions regarding the event. According to some embodiments, the gathering of feature data may further include: fetching the underlying data; performing natural language processing (NLP) analyses on the written descriptions; and saving the underlying data and at least one result of the NLP analyses as the feature data.

According to some embodiments, the feeding of the feature data may be performed in response to an amount of the feature data gathered being equal to or greater than a predetermined threshold.

According to some embodiments, the machine learning model may be pre-trained with feature data of past events and corresponding data describing actual impact zones of past events.

The present disclosure also teaches a system including one or more hardware computer processors configured with computer-executable instructions that, when executed, may cause the one or more hardware computer processors to: gather feature data from electronic updates of an event; feed the feature data to a machine learning model; cause the machine learning model to estimate in real-time a current spatial impact zone of the event based on the feature data; cause the machine learning model to output in real-time data describing the estimated current spatial impact zone of the event; receive data describing an actual spatial impact zone of the event as the event is occurring; save the data describing the actual spatial impact zone with the feature data; and retrain the machine learning model on a batch basis with the data describing the actual spatial impact zone and the feature data.

According to some embodiments, the one or more hardware computer processors may be configured with the computer-executable instructions that, when executed, may further cause the one or more hardware computer processors to: determine a probability that an asset is affected by the event based on the data describing the estimated current spatial impact zone of the event.

According to some embodiments, the one or more hardware computer processors may be configured with the computer-executable instructions that, when executed, may further cause the one or more hardware computer processors to: determine whether to adjust output of the machine learning model, which represents the data describing the estimated current spatial impact zone of the event, based on whether the data describing the actual spatial impact zone at a time of the output is different from the data describing the estimated current spatial impact zone of the event.

According to some embodiments, the electronic updates of the event may at least include underlying data and written descriptions regarding the event. According to some embodiments, the gathering of feature data may further include: fetching the underlying data; performing NLP analyses on the written descriptions; and saving the underlying data and at least one result of the NLP analyses as the feature data.

According to some embodiments, the feeding of the feature data may be performed in response to an amount of the feature data gathered being equal to or greater than a predetermined threshold.

According to some embodiments, the machine learning model may be pre-trained with feature data of past events and corresponding data describing actual impact zones of past events.

The present disclosure also teaches a non-transitory computer-readable storage medium with an executable program stored thereon, wherein the program may instruct one or more processors to perform the following steps: gather feature data from electronic updates of the event; feed the feature data to a machine learning model; cause the machine learning model to estimate in real-time the current spatial impact zone of the event based on the feature data; cause the machine learning model outputting in real-time data to describe the estimated current spatial impact zone of the event; receive data describing an actual spatial impact zone of the event as the event is occurring; save the data describing the actual spatial impact zone with the feature data; and retrain the machine learning model on a batch basis with the data describing the actual spatial impact zone and the feature data.

According to some embodiments, the program may further instruct the one or more processors to perform the following step: determine a probability that an asset is affected by the event based on the data describing the estimated current spatial impact zone of the event.

According to some embodiments, the program may further instruct the one or more processors to perform the following step: determine whether to adjust output of the machine learning model, which represents the data describing the estimated current spatial impact zone of the event, based on whether the data describing the actual spatial impact zone at a time of the output is different from the data describing the estimated current spatial impact zone of the event.

According to some embodiments, the electronic updates of the event may at least include underlying data and written descriptions regarding the event. According to some embodiments, the gathering of feature data may include: fetching the underlying data; performing NLP analyses on the written descriptions; and saving the underlying data and at least one result of the NLP analyses as the feature data.

According to some embodiments, the feeding of the feature data may be performed in response to an amount of the feature data gathered being equal to or greater than a predetermined threshold.

According to some embodiments, the machine learning model may be pre-trained with feature data of past events and corresponding data describing actual impact zones of past events.

### BRIEF DESCRIPTION OF THE DRAWINGS

The components in the drawings are not necessarily to scale relative to each other. Like reference numerals designate corresponding parts throughout the several views.

FIG. 1 is a flow diagram illustrating the presently disclosed technology, according to one example embodiment.

FIG. 2 illustrates one of the means by which the presently disclosed technology may determine whether an asset is likely to be impacted by an event based on the output of the machine learning model.

FIG. 3 illustrates another means by which the presently disclosed technology determines whether an asset is affected by an event, based on the estimated current spatial impact zone, according to one example embodiment.

FIG. 4 is a flow diagram illustrating an optional function of the presently disclosed technology, namely adjusting the output of the machine learning model based on the data describing the actual spatial impact zone at the time of the output, according to one example embodiment.

FIG. 5 is a flow diagram illustrating an optional function of the presently disclosed technology, namely ensuring that the feature data is fed to the machine learning model after sufficient feature data has been gathered, according to one example embodiment.

FIG. 6 is a flow diagram illustrating one means for gathering feature data from electronic updates of the event, according to one example embodiment.

FIG. 7 is a block diagram illustrating an example device on which the presently disclosed technology may be implemented, according to one example embodiment.

FIG. 8 is a diagram illustrating an example networking environment in which the presently disclosed technology may be implemented, according to one example embodiment.

FIG. 9 is a diagram illustrating an interface via which a user of the presently disclosed technology can interact with the presently disclosed system, according to one example embodiment.

### DETAILED DESCRIPTION

Events such as shootings, explosions, fires, transportation accidents and industrial accidents may negatively impact assets located in the nearby area. For example, if a shooting happens near a hotel, the hotel owner may have to evacuate the hotel building and thus suffer from economic loss. An event's negative impact on an asset may take the form of any damage or disruption, such as shattered windows, evacuations, closed facilities, or traffic backups. Also, businesses impacted by such events may have a duty of care to customers, employees and other people on the property of the business to take reasonable actions to mitigate harm to those people resulting from such events. Employees of such businesses may also have such a duty of care to customers and other people on the property of the business.

Various updates of an event, fueled by journalists, can easily be found online. However, the owners of nearby assets cannot easily determine whether the event is likely to impact their assets based on the updates. Therefore, the owners of nearby assets may have trouble determining the actions they need to take in response to the event (i.e., to evacuate a hotel building) to fulfill their duty of care and estimating the economic loss they may suffer due to the event. The spatial impact zone of an event may be estimated from the type and severity of an event; for example, a car accident of medium severity may impact the traffic within two miles, and the spatial impact zone, in this case, is a circle with a radius of 2 miles centered at the location of the accident. Nevertheless, such estimation may not be sufficiently accurate. Also, untimely updates from several hours ago may not accurately depict the state of the event in real-time, which further hinders the asset owners' ability to make decisions in response to the event. To solve these technical problems, the presently disclosed technology offers a way to estimate the current spatial impact zone of an event in real-time based on the electronic updates of an event using machine learning techniques. Based on the estimated current spatial impact zone, owners of assets near the center of the event can determine whether their assets are likely to be impacted and take action accordingly.

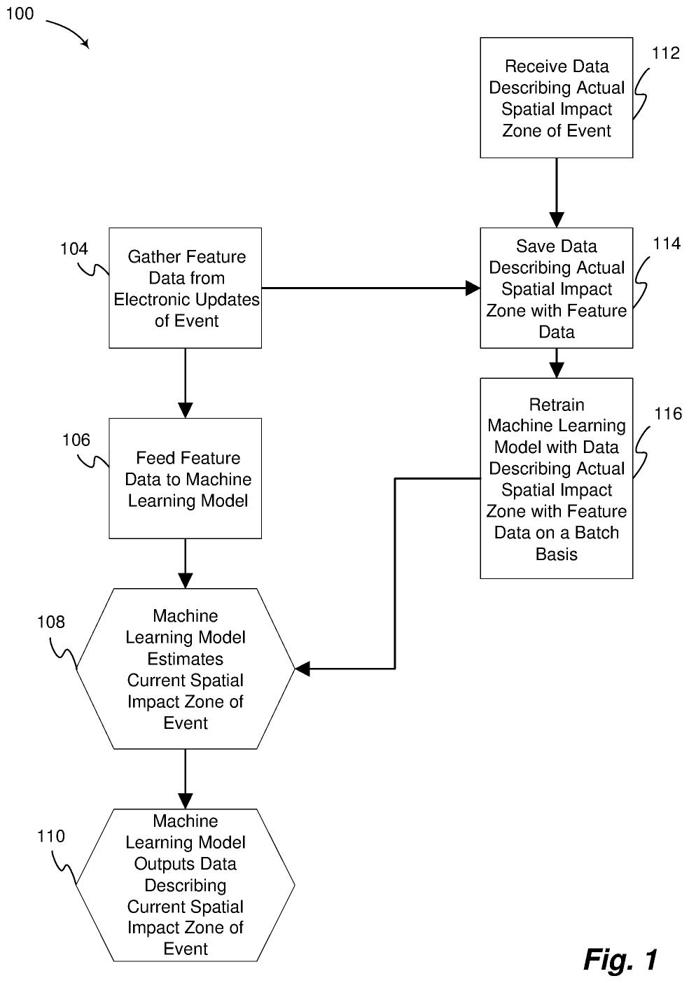

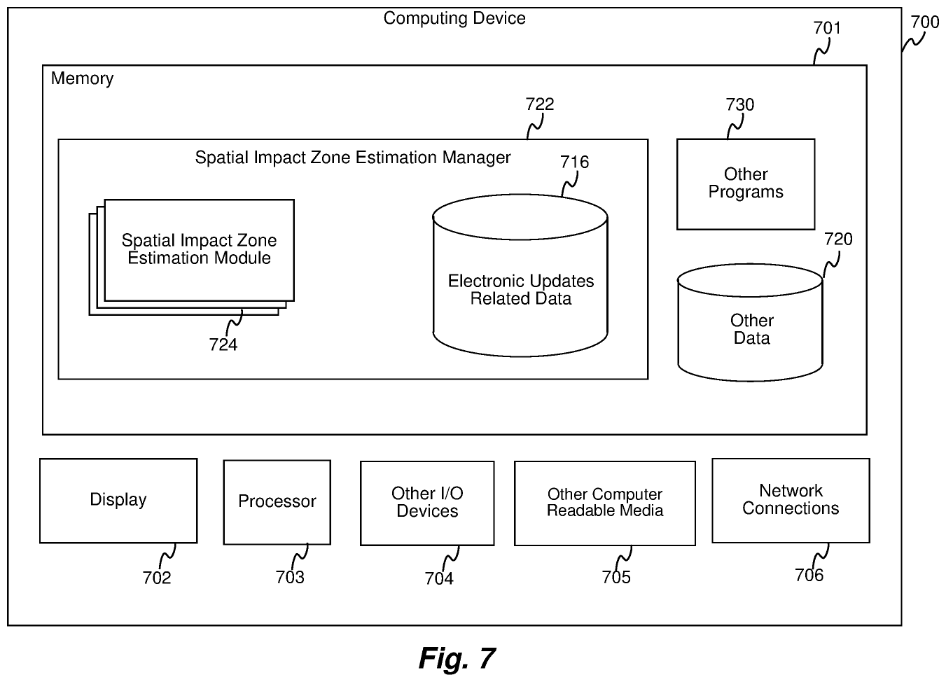

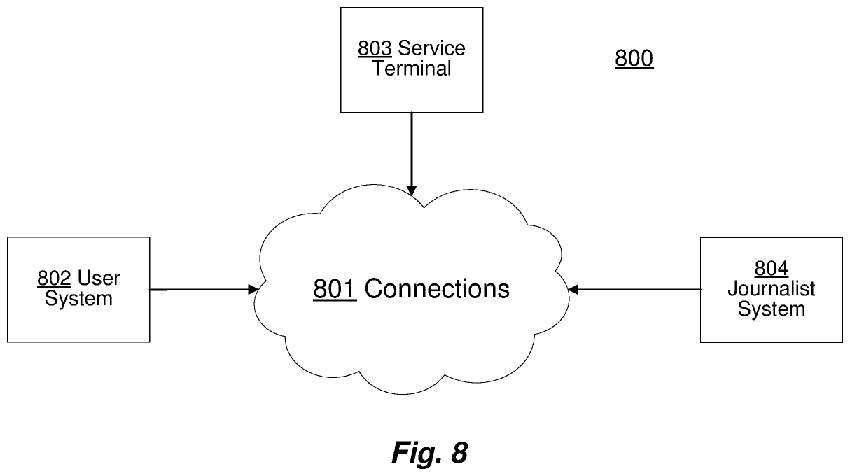

FIG. 1 is a flow diagram illustrating the presently disclosed technology, according to one example embodiment. The presently disclosed technology teaches a computerized method 100 that can be performed by one or more computing devices 700 as shown in FIG. 7, which will be discussed further below. The computerized method 100 can be performed in the network environment 800 as shown in FIG. 8, which will also be discussed further below.

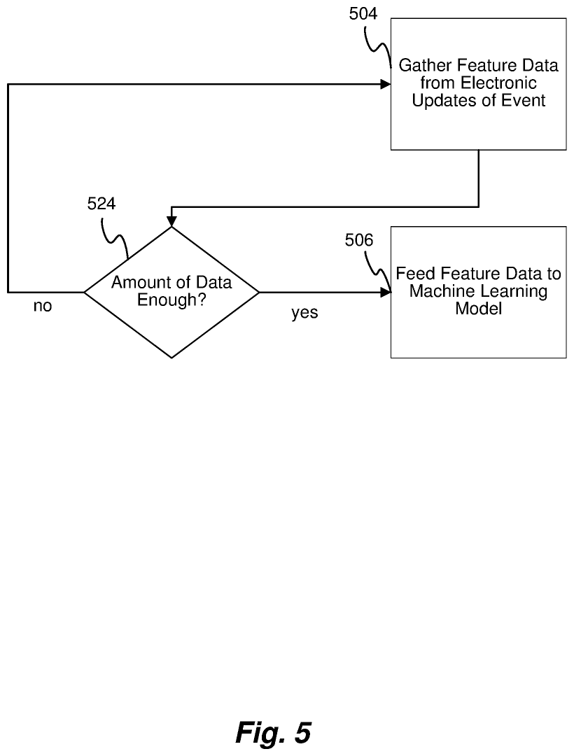

At 104, feature data is gathered from electronic updates of the event, by one or more processors 703. The event can be emergencies such as shootings, explosions, fires, earthquakes, transportation accidents, and industrial accidents that can negatively impact the nearby area, and the impact zones of these events may expand or shrink over time according to the development of the event. An event's negative impact on an asset may take the form of any damage or disruption, such as shattered windows, evacuations, closed facilities, or traffic backups. The electronic updates of the event can be provided by journalists. The electronic updates of the event can also be obtained from social media. The electronic updates can contain numerical data, categorical data, and written descriptions of the events. Feature data can be gathered from electronic updates with one or more statistical means and machine learning algorithms. One way of gathering feature data from electronic updates is demonstrated in FIG. 5, according to one example embodiment. Nevertheless, the gathering of feature data can also be performed in other ways. For example, electronic updates of the event may also be received as mobile geo-located data via user system 802 (e.g., tips that users of the system provide via an application on their individual mobile devices). In some embodiments, such tips may include underlying data and/or written descriptions regarding the event. The system may automatically correlate a geographic location that was associated with the geo-located data based on a current location of the mobile device when the geo-located data was received to a particular event at a location in proximity to the correlated geographic location.

Feature data can provide information about the event itself, such as the time of the event, the location of the event, the estimated severity of the event, the type of the event (e.g., shooting, explosion, car accident, industrial accident, fire, earthquake, etc.), the number of people dead or injured due to the event, etc. Feature data can also include information about the environmental characteristics of the nearby area, such as the traffic flow, the population density, whether the event has happened in a war zone, etc. Feature data can also provide information about the development of the event, such as whether the police, ambulance, or firefighters have arrived, whether the dead bodies have been removed, etc. Feature data can also include information reflecting the actual spatial impact zone of the event at a certain time (e.g., Fifth Avenue has been blocked due to an accident). The feature data can also include information about the electronic update itself, such as the time and the source of the electronic update.

After the gathering of feature data, at 106, the feature data is fed to a machine learning model, according to one example embodiment. The machine learning model can utilize one or a combination of machine learning algorithms, such as decision trees, random forests, Bayesian models, support vector machines (SVM), k-nearest neighbors (k-NNs), neural networks, etc. The machine learning model may be a supervised learning model or an unsupervised learning model. The feature data may or may not be pre-processed before feeding to the machine learning model. According to some embodiments, the machine learning model is pre-trained with feature data of past events and corresponding data describing impact zones of past events.

At 108, the machine learning model estimates the current spatial impact zone of an event. At 110, the machine learning model outputs the estimated current spatial impact zone of an event. The spatial impact zone is an area within which an asset is, or likely to be, negatively impacted by the event. An event's negative impact on an asset may take the form of any damage or disruption, such as shattered windows, evacuations, closed facilities, or traffic backups. For example, if two cars collide, one or a few lanes on the street may be blocked, and the traffic flow may be slowed down starting one mile away from the location of the accident. The current spatial impact zone of the event may be presented as a list of coordinates indicating the boundary of the spatial impact zone or may be presented in other forms. According to some embodiments, the machine learning model estimates the spatial impact zone and outputs its estimation in real-time, taking the passage of time and new electronic updates regarding the event into account.

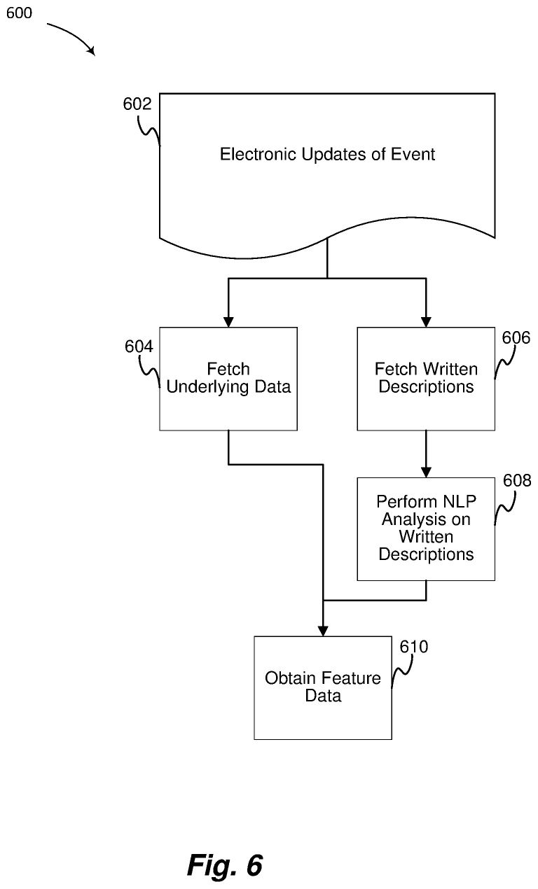

At 112, data describing the actual spatial impact zone of the event is received. The data describing the actual spatial impact zone may be retrieved from the electronic updates. The data describing the actual spatial impact zone may be a part of the feature data. Ideally, the data describing the actual spatial impact zone may take the form of explicit boundaries defining the area that is impacted or likely to be impacted due to the event. Realistically, the data describing the actual spatial impact zone is more likely to take the form of updates describing the state at a certain location after the event has happened. For example, an update describing the spatial impact zone of an event may read as follows: “First Avenue has been blocked”, “the elementary school has been evacuated”, or “the fire has spread to Third Street.” Thus, data describing the actual spatial impact zone may not describe the complete spatial impact zone of an event at a certain time. For example, there may be an electronic update providing that First Avenue has been blocked due to an explosion, but the information regarding whether Second Avenue has been blocked, or has been otherwise impacted because of the explosion may not be available. The data describing the actual spatial impact zone may not explicitly describe the boundary of the actual spatial impact zone for the same reason. The data describing the actual spatial impact zone may not reflect the impact of the event in real-time. For example, a tweet sent at 5 p.m. may read like: “First Avenue is blocked at 4 p.m.” There is no way of knowing whether the First Avenue is still blocked at 5 p.m. from the content of the tweet. The data describing the actual spatial impact zone may be gathered from raw data like news articles and social media posts with one or more statistical means or machine learning algorithms. For example, similar to the method explained in FIG. 6, the raw data may be split into the underlying numerical and categorical data and the written description. The underlying data relevant to establishing the actual impact zone of an event may be fetched from the raw data. An NLP analysis may be performed upon the written description to extract information relevant to establishing the actual spatial impact zone of the event. Data describing the actual impact zone of an event may also contain additional information such as time, source of the data, etc.

Data describing the actual spatial impact zone of an event may be used to adjust the spatial impact zone estimated by the machine learning model or to train the machine learning model so that the accuracy of the machine learning model's estimate may be enhanced. At 114, data describing the actual spatial impact zone is saved with the corresponding feature data, according to one example embodiments. At 116, the machine learning model is retrained with the data describing the actual spatial impact zone and the corresponding feature data on a batch basis. The machine learning data may be retrained every time a certain amount of new data describing the actual spatial impact zone is gathered, or at predetermined time intervals.

According to some embodiments, the current spatial impact zone may be used to determine which assets are likely to be impacted.

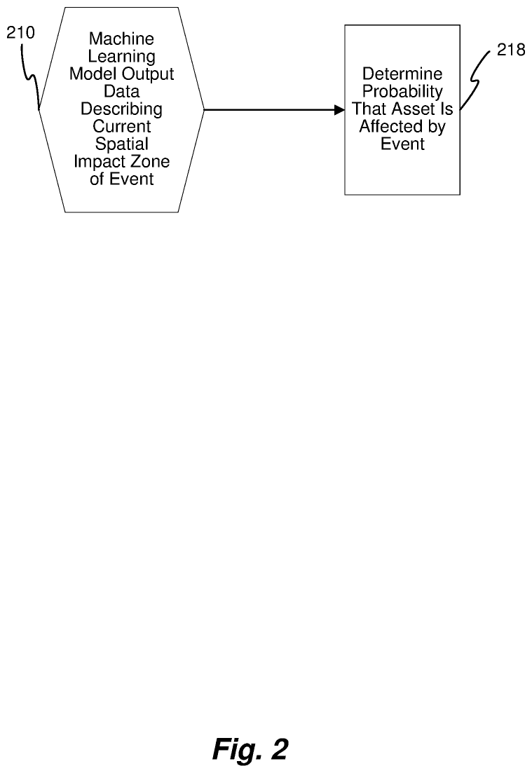

FIG. 2 illustrates one of the means by which the presently disclosed technology may determine whether an asset is likely to be impacted by an event based on the output of the machine learning model. At 218, the probability that an asset is affected by an event is determined according to the current spatial impact zone outputted by the machine learning algorithm at 210. The owner of the asset may determine whether to take action in order to protect the asset based on the probability. Alternatively, the presently disclosed system may send an alert to the owner of the asset if the probability reaches or exceeds a certain threshold. The threshold may be preset by the system as a fixed value. Alternatively, the threshold may be preset by the system based on the type of the asset and the scale of the asset. These factors may affect the risk preference of an asset owner. For example, the owner of a school may be more risk-averse than the owner of a grocery store, and the owner of a larger asset may be more risk-averse than the owner of a smaller asset of the same type. The threshold may also be adjusted by the owner of the asset.

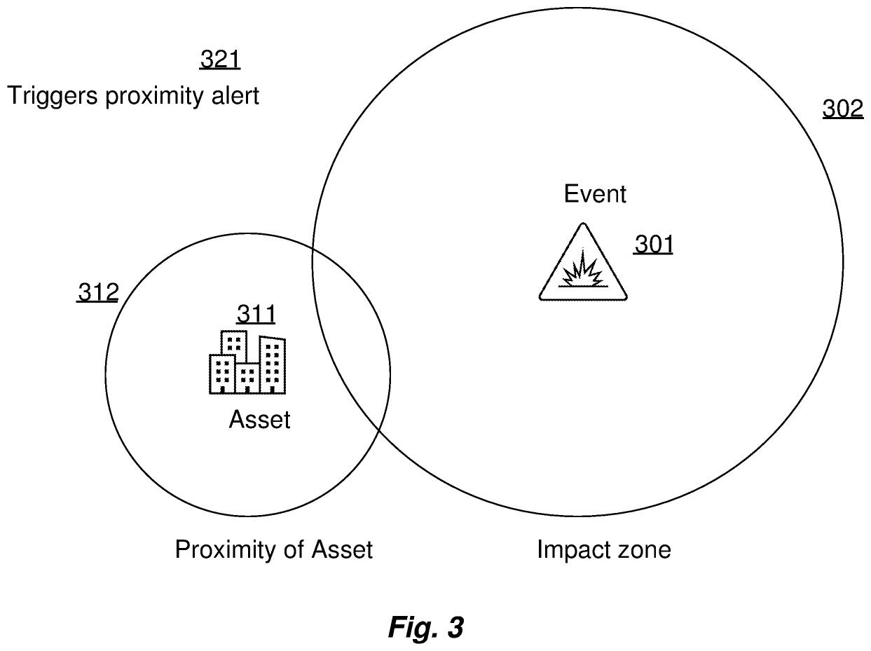

FIG. 3 illustrates another means with which the presently disclosed technology determines whether an asset is affected by an event, based on the estimated current spatial impact zone, according to one example embodiment. In FIG. 3, the current spatial impact zone 302 of an event 301 is estimated by the machine learning model based on electronic updates of the event. If the proximity 312 of an asset 311 overlaps with the current spatial impact zone 302, the presently disclosed system triggers a proximity alert 321. According to some embodiments, the proximity is a circle centered at the asset. The radius of the circle may be predetermined by the presently disclosed system as a fixed value, based on the type and scale of the asset. The radius of the circle may also be adjusted by the owner of the asset. The proximity does not have to be a circle. For example, if the asset is a rectangular university campus located in an area with a grid plan, and the system triggers a proximity alert when an event has negatively impacted a location that is less than one block away from the campus, the proximity may also have the shape of a rectangle.

The idea behind the proximity of an asset is that an asset not located within the spatial impact zone of an event may nevertheless be sufficiently close to be negatively affected by the event. For example, if a shooting happens near a restaurant, the spatial impact zone may not be large enough so that the safety of the restaurant can be compromised by the shooting. However, people may get scared because of the shooting and thus refrain from visiting the nearby area, and therefore, the restaurant may suffer an economic loss due to the shooting. The size and shape of proximity may be determined based on the shape and scale of the asset. For example, the owner of a school may be more risk-averse than the owner of a grocery store, and the former may set the radius of the proximity at a larger value. Also, the owner of an asset of a larger scale may want to set the radius of the proximity at a larger value. For example, a small grocery store may only attract customers from the neighborhood, but a large grocery store like Walmart may attract customers from the whole city. Therefore, if a shooting happened ten blocks away from both the small grocery store and Walmart, the small grocery store may not suffer from economic loss because of the shooting, but Walmart may. Also, the radius may be set based on the extent of the duty of care the business or school has to the people it serves and occupants of its buildings.

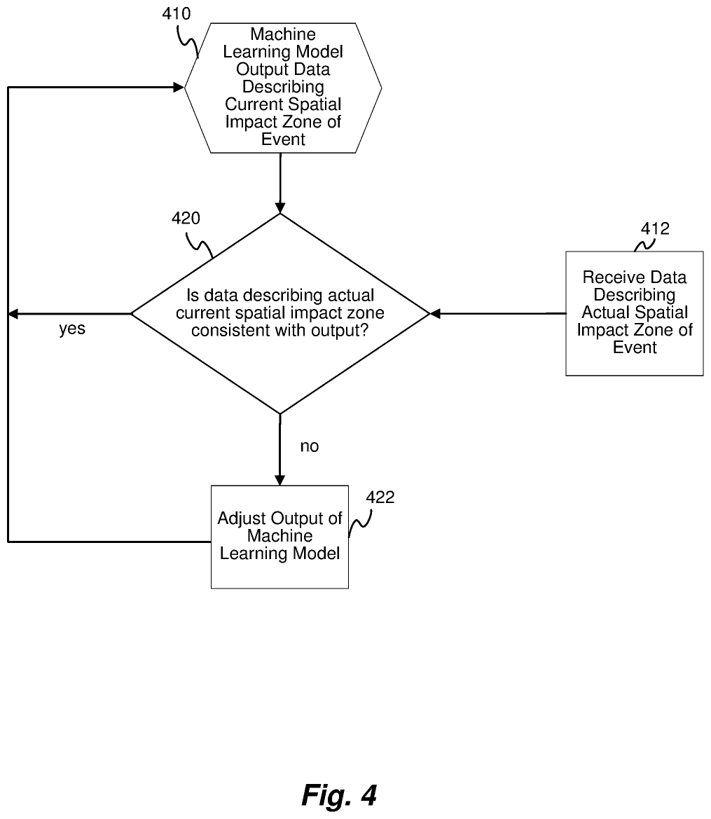

According to one example embodiment as illustrated in FIG. 4, data describing the actual spatial impact zone at a time of the output may also be used to adjust the output of the machine learning model, which describes the current spatial impact zone estimated by the machine learning model based on the feature data. At 420, data describing the actual spatial impact zone at a time of the output, as received at 412, is compared to the output of the machine learning model at 410. If the data describing the actual spatial impact zone at a time of the output is inconsistent with the output, at 422, the output of the machine learning model at 410 may be adjusted accordingly. If the data describing the actual spatial impact zone at a time of the output is consistent with the output, the output of the machine learning model does not need to be adjusted. For example, if data describing the actual spatial impact zone at a time of the output provides information indicating that First Avenue has been blocked due to a nearby traffic accident, but the estimated spatial impact zone does not cover First Avenue, the output of the machine learning model may be adjusted accordingly so that the estimated spatial impact zone covers First Avenue. Note that the data describing the actual spatial impact zone may not describe the complete spatial impact zone at a given time, and may not provide a clear boundary of the actual spatial impact zone. In addition, the data describing the actual spatial impact zone may not be up to date. Combining the data describing the estimated and actual spatial impact zones can enhance the accuracy of the presently disclosed technology's prediction, and help the owners of assets make more informed decisions regarding their assets' safety.

According to some embodiments, the machine learning model only runs when there is enough feature data gathered through iterative updates. According to one example embodiment as shown in FIG. 5, the feature data is fed to the machine learning model in response to the amount of feature data reaching or exceeds a certain threshold. At 524, if the amount of feature data gathered at 504 reaches or exceeds a certain threshold, the feature data is fed to the machine learning model at 506; if the amount of feature data falls below the threshold, the gathering of feature data continues until the amount of feature data reaches or exceeds the threshold. According to another example embodiment, the feature data is fed to the machine learning model in response to the number of electronic updates reaching or exceeding a certain threshold. For example, the feature data may be fed to the machine learning model after a minimum of three electronic updates is collected from journalists. Other methods may also be used to determine whether there is enough feature data gathered for the machine learning model to operate upon.

FIG. 6 is a flow diagram illustrating the process 600 of gathering feature data from electronic updates of an event, according to one example embodiment. The electronic updates of an event 602 can contain at least two parts: the underlying data and the written description. The underlying data may include numerical and categorical data describing the event, such as the time of the event; the location of the event; the type of the event (e.g., shooting, car accident, fire, earthquake, industrial accident, etc.); the estimated severity of the event; whether the event has happened in a war zone like some areas of Syria or Afghanistan; whether the police, the fire department or the ambulance has reacted to the event; the number of people dead or injured because of the event; etc. The written description can be one or more paragraphs in one or more natural languages describing the event, its development, and its impact. The written description may take different formats: it may be in the form of a newspaper article or a social media post. To obtain the feature data, the underlying data and the written description can be processed separately.

At 604, the underlying data is fetched as part of the feature data, by one or more processors 703. At 606, the written description is fetched for further processing, by one or more processors 703. At 608, natural language processing (NLP) analysis is performed on the written description, by one or more processors 703, to extract information relevant to estimating the spatial impact zone of the event, such as the number of people dead or injured due to the event, whether the police have arrived, whether a certain street has been blocked, etc. Such information may or may not be included in the underlying data. The NLP analysis can be performed by statistical methods or using neural networks. The NLP analysis may include morphological steps such as lemmatization, morphological segmentation, part-of-speech tagging, and stemming; syntactic analysis such as grammar induction, sentence breaking, and parsing; lexical semantics analysis such as lexical semantics, distributional semantics, named entity recognition (NER), sentiment analysis, terminology extraction, and word sense disambiguation; relational semantics analysis such as relationship extraction, semantic parsing, and semantic role labeling; discourse analysis, etc. At 610, the underlying data and the features extracted from performing NLP analysis upon the written description are combined as the feature data.

FIG. 7 is a block diagram illustrating elements of an example computing device 700 utilized in accordance with at least some embodiments of the techniques described herein. Illustratively, the computing device 700 corresponds to the service terminal 803, on which the presently disclosed method as illustrated in FIGS. 1, 2, and 4-6 is performed, according to some embodiments. The computerized method may also be performed on more than one devices connected by a local network or connected to the internet. For example, if the amount of electronic updates is enormous, the gathering of feature data and the training of the machine learning model may be performed by multiple computing devices in parallel. The different functions in the method may also be performed on different devices. For example, the gathering of feature data from electronic updates 104 may be performed on the journalist system 804. Determining the probability that an asset is impacted by an event from the estimated spatial impact zone 302 may be performed on the user system 802.

In some embodiments, one or more general purpose or special purpose computing systems or devices may be used to implement the computing device 700. In addition, in some embodiments, the computing device 700 may comprise one or more distinct computing systems or devices, and may span distributed locations. Furthermore, each block shown in FIG. 7 may represent one or more such blocks as appropriate to a specific embodiment or may be combined with other blocks. Also, the spatial impact zone estimation manager 722 may be implemented in software, hardware, firmware, or in some combination to achieve the capabilities described herein.

As shown, the computing device 700 comprises a non-transitory computer memory (“memory”) 701, a display 702 (including, but not limited to a light emitting diode (LED) panel, cathode ray tube (CRT) display, liquid crystal display (LCD), touch screen display, projector, etc.), one or more CPUs, GPUs, or other processors 703, Input/Output (“I/O”) devices 704 (e.g., keyboard, mouse, RF or infrared receiver, universal serial bus (USB) ports, High-Definition Multimedia Interface (HDMI) ports, other communication ports, and the like), other computer-readable media 705, and network connections 706. The spatial impact zone estimation manager 722 is shown residing in memory 701. In other embodiments, some portion of the contents and some, or all, of the components of the spatial impact zone estimation manager 722 may be stored on or transmitted over the other computer-readable media 705. The components of the computing device 700 and the spatial impact zone estimation manager 722 can execute on one or more processors 703 and implement applicable functions described herein. In some embodiments, the spatial impact zone estimation manager 722 may operate as, be part of, or work in conjunction or cooperation with other software applications stored in memory 701 or on various other computing devices. In some embodiments, the spatial impact zone estimation manager 722 also facilitates communication with peripheral devices via the I/O devices 704, or with another device or system via the network connections 706.

The one or more spatial impact zone estimation modules 724 are configured to perform actions, directly or indirectly, to gather feature data from electronic updates about an event, initialize and train the machine learning model, feed the feature data to the machine learning model, obtain the output from the machine learning module that represents the estimated spatial impact zone of the event, receive data describing the actual spatial impact zone of the event, save the data describing the actual spatial impact zone of the event with the corresponding feature data, retrain the machine learning module with the data describing the actual spatial impact zone of the event and the corresponding feature data, etc. The one or more spatial impact zone estimation modules 724 may also be configured to perform actions related, directly or indirectly, to determining the probability that an asset is impacted by the event according to the output of the machine learning model, to adjusting the output of the machine learning model based on the data describing the actual spatial impact zone at a time of the output, etc. In some embodiments, the spatial impact zone estimation module(s) 724 stores, retrieves, or otherwise accesses at least some electronic updates-related data on some portion of the electronic updates-related data storage 716 or other data storage internal or external to the computing device 700.

Other code or programs 730 (e.g., further data processing modules, a program guide manager module, a Web server, and the like), and potentially other data repositories, such as data repository 720 for storing other data, may also reside in the memory 701, and can execute on one or more processors 703. Of note, one or more of the components in FIG. 7 may or may not be present in any specific implementation. For example, some embodiments may not provide other computer readable media 705 or a display 702.

In some embodiments, the computing device 700 and spatial impact zone estimation manager 722 include API(s) that provides programmatic access to add, remove, or change one or more functions of the computing device 700. In some embodiments, components/modules of the computing device 700 and spatial impact zone estimation manager 722 are implemented using standard programming techniques. For example, the spatial impact zone estimation manager 722 may be implemented as an executable running on the processor(s) 703, along with one or more static or dynamic libraries. In other embodiments, the computing device 700 and spatial impact zone estimation manager 722 may be implemented as instructions processed by a virtual machine that executes as one of the other programs 730. In general, a range of programming languages known in the art may be employed for implementing such example embodiments, including representative implementations of various programming language paradigms, including but not limited to, object-oriented (e.g., Java, C++, C#, Visual Basic.NET, Smalltalk, and the like), functional (e.g., ML, Lisp, Scheme, and the like), procedural (e.g., C, Pascal, Ada, Modula, and the like), scripting (e.g., Perl, Ruby, Python, JavaScript, VBScript, and the like), or declarative (e.g., SQL, Prolog, and the like).

In a software or firmware implementation, instructions stored in a memory configure, when executed, one or more processors of the computing device 700 to perform the functions of the spatial impact zone estimation manager 722. In some embodiments, instructions cause the processor(s) 703 or some other processor, such as an I/O controller/processor, to perform at least some functions described herein.

The embodiments described above may also use well-known or other synchronous or asynchronous client-server computing techniques. However, the various components may be implemented using more monolithic programming techniques as well, for example, as an executable running on a single CPU computer system, or alternatively decomposed using a variety of structuring techniques known in the art, including but not limited to, multiprogramming, multithreading, client-server, or peer-to-peer, running on one or more computer systems each having one or more CPUs or other processors. Some embodiments may execute concurrently and asynchronously, and communicate using message passing techniques. Equivalent synchronous embodiments are also supported by a spatial impact zone estimation manager 722 implementation. Also, other functions could be implemented or performed by each component/module, and in different orders, and by different components/modules, yet still achieve the functions of the computing device 700 and spatial impact zone estimation manager 722.

In addition, programming interfaces to the data stored as part of the computing device 700 and spatial impact zone estimation manager 722, can be available by standard mechanisms such as through C, C++, C#, and Java APIs; libraries for accessing files, databases, or other data repositories; scripting languages such as XML; or Web servers, FTP servers, NFS file servers, or other types of servers providing access to stored data. The electronic updates-related data storage 716 and data repository 720 may be implemented as one or more database systems, file systems, or any other technique for storing such information, or any combination of the above, including implementations using distributed computing techniques.

Different configurations and locations of programs and data are contemplated for use with techniques described herein. A variety of distributed computing techniques are appropriate for implementing the components of the illustrated embodiments in a distributed manner including but not limited to TCP/IP sockets, RPC, RMI, HTTP, and Web Services (XML-RPC, JAX-RPC, SOAP, and the like). Other variations are possible. Other functionality could also be provided by each component/module, or existing functionality could be distributed amongst the components/modules in different ways, yet still achieve the functions of the spatial impact zone estimation manager 722.

Furthermore, in some embodiments, some or all of the components of the computing device 700 and spatial impact zone estimation manager 722 may be implemented or provided in other manners, such as at least partially in firmware or hardware, including, but not limited to one or more application-specific integrated circuits (“ASICs”), standard integrated circuits, controllers (e.g., by executing appropriate instructions, and including microcontrollers or embedded controllers), field-programmable gate arrays (“FPGAs”), complex programmable logic devices (“CPLDs”), and the like. Some or all of the system components or data structures may also be stored as contents (e.g., as executable or other machine-readable software instructions or structured data) on a computer-readable medium (e.g., as a hard disk; a memory; a computer network, cellular wireless network or other data transmission medium; or a portable media article to be read by an appropriate drive or via an appropriate connection, such as a DVD or flash memory device) so as to enable or configure the computer-readable medium or one or more associated computing systems or devices to execute or otherwise use, or provide the contents to perform, at least some of the described techniques.

FIG. 8 is a diagram showing an example networking environment 800 in which embodiments of the presently disclosed technology may be implemented, according to one example embodiment. The connections 801 may be a local network or the internet. The connections 801 may be implemented by software and hardware means. The software part of the connections 801 may comprise implementation of network protocols, such as TCP, UDP, IP, etc. The hardware part of the connections 801 may contain components such as switches, routers, cables and satellites that enables a variety of computing devices to communicate with each other.

The user system 802 can contain a desktop or laptop computer, smartphone, tablet, smartwatch, or other computing devices. The user system 802 can contain one or more I/O devices that enable the user to communicate with the computing device, such as keyboards, mice, touchscreens, microphones, cameras, display screens, speakers, etc. The user system 802 can contain one or more network devices that enable the user system to communicate with the service terminal 803 and the journalist system 804 via the connections 801, such as routers, switches, cables, etc. The computing device can contain I/O and network modules that enable the computing device to access the I/O and network devices. The user may interact with the presently disclosed system via an interface 900, which will be described in further detail below, from the user system 802. The user system 802 may perform part of the presently disclosed computerized method, for example, determining the probability that an asset is impacted by an event.

Service terminal 803 can contain a server or other computing devices. The service terminal 803 can contain one or more network connection modules that enable the service terminal to communicate with the user system 802 and the journalist system 804 via the connections 801. According to some embodiments, the service terminal may perform the entire or part of the presently disclosed computerized method. The presently disclosed computerized method may also be performed by multiple service terminals 803. For example, if the number of electronic updates is enormous, the gathering of feature data from electronic updates may be performed by multiple service terminals 803 in parallel. Part of the presently disclosed computerized method may also be performed by the user system 802 and the journalist system 804.

The journalist system 804 can contain a desktop or laptop computer, smartphone, tablet, smartwatch, or other computing devices. The journalist system 804 can contain one or more I/O devices that enable the user to communicate with the computing device, such as keyboards, mice, touchscreens, microphones, cameras, display screens, speakers, etc. The journalist system 804 can contain one or more network devices that enable the user system to communicate with the service terminal 803 and the journalist system 804 via the connections 801, such as routers, switches, cables, etc. The computing device can contain I/O modules and network modules that enable the computing device to access the I/O devices and network devices. The journalist system 804 may perform part of the presently disclosed computerized method, for example, gathering feature data from electronic updates.

One or more of the user system 802 and the journalist system 804 may include one or more hardware and/or software components corresponding to those of computing device 700 as applicable to perform the functions of the user system 802 and the journalist system 804 as described herein.

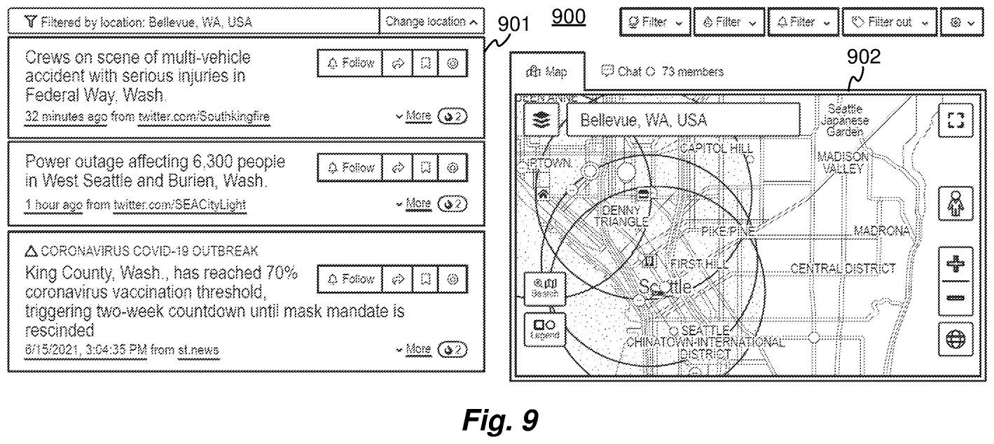

FIG. 9 is a diagram illustrating an interface 900 via which a user of the presently disclosed technology can interact with the presently disclosed system, according to one example embodiment. Note that the interface of the presently disclosed technology may be implemented in many ways. The example embodiments described herein do not constitute limitations upon the scope of the present disclosure. The interface 900 can be displayed on the user system 802, according to some embodiments. The interface 900 may be displayed on a monitor, a touchscreen, the display screen of a computing device such as a desktop, a laptop, a smartphone, a tablet, a smartwatch, etc. The layout of the interface 900 may be modified according to the shape and size of the device on which the interface is displayed.

According to some embodiments, the electronic updates module 901 is displayed on the interface 900. The electronic updates module 901 shows the basic information about each electronic update, such as a short description of the update, the time of the update, the source of the update, the severity of the event, etc. The user may also interact with the electronic updates module 901 to obtain additional information about an electronic update. According to the example embodiment as illustrated in FIG. 9, if a user clicks on the text “more,” additional information about an electronic update such as the location of the event, the type of the event, or keywords about an event, will be displayed. The user can also filter the electronic updates by location. For example, if the user owns a restaurant in Bellevue, Wash., and she wants to learn about the events happening in Bellevue that may affect the operation of her restaurant, she may filter the electronic updates by location so that only electronic updates regarding events happening or having an impact in Bellevue will be displayed. The user can also filter the electronic updates by the type of the event, the severity of the event, or other characteristics of the event, according to some embodiments. The user can also follow an event, share an update, and save an update by clicking on the respective buttons, according to the example embodiment as illustrated in FIG. 9.

According to some embodiments, the map module 902 is displayed on the interface 900. The map may be zoomed to a selected location. The map may be displayed in selected styles, such as google map style, satellite, etc. The center of an event, the current spatial impact zone of the event, an asset, and the proximity of the asset may be displayed on the map. The user can select the events and assets that are displayed on the map. The user may adjust the shape and dimensions of the proximity of an asset. The user may use one or more filters to select the events to be displayed on the map, such as the location of the event, the type of the event, the severity of the event, etc.

When the user select an event on the map, the user system 802 sends a request regarding the event being selected to the service terminal 803. According to some embodiments, the service terminal 803 may gather feature data from the electronic updates regarding the event and feed the feature data to a machine learning model that outputs the estimated current spatial impact zone of the event. According to some embodiments, the output of the machine learning model may be adjusted based on data describing the actual spatial impact zone of the event at a time of the output. According to some embodiments, at the time the service terminal 803 receives the request from the user system 802, the machine learning model may have already calculated the estimated current spatial impact zone of the event per one or more requests from other users, and the service terminal may simply obtain the output from the machine learning model without performing the whole process from feature data gathering. The service terminal 803 may send one or more messages back to the user system 802 that contains the information regarding the output of the machine learning model in real time. The interface 900 may display the current spatial impact zone, in real time.

According to some embodiments, based on the user's selection of assets, the user system 802 may send a message to the service terminal 803 that contains the information about the selected assets. According to some embodiments, the service terminal 803 may determine the probability that a selected asset is affected by the event based on the output of the machine learning model. According to some embodiments, the service terminal 803 may send a proximity alert message back to the user system 802 if the probability reaches or exceeds a predetermined threshold, and the interface 900 may display the proximity alert accordingly. According to some other embodiments, the user system 802 may determine the probability that a selected asset is affected by the event based on the output of the machine learning model, and trigger a proximity alert if the probability reaches or exceeds a predetermined threshold. The interface 900 may display the proximity alert accordingly.

According to some embodiments, based on the user's inputs, the user system 802 may send a message to the service terminal 803 that contains the information about the selected asset and the shape and dimensions of the proximity of an asset as determined by the user. According to some embodiments, the service terminal 803 may determine whether the proximity overlaps with the current spatial impact zone of the event, in which case, a proximity alert should be triggered. The service terminal 803 may send a corresponding message back to the user system 802, and the interface 900 may display the proximity alert accordingly. Or, according to some embodiments, the user system 802 may determine whether the proximity overlaps with the current spatial impact zone, and the interface 900 may display a proximity alert accordingly.

While various embodiments have been described herein above, it is to be appreciated that various changes in form and detail may have been made without departing from the spirit and scope of the invention(s) presently or hereafter claimed.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A computerized method for estimating a current spatial impact zone of an event in real-time, comprising:
electronically gathering, by at least one computer processor, feature data from electronic updates of the event;
electronically feeding, by at least one computer processor, the feature data to a machine learning model wherein:
the machine learning model estimates in real-time the current spatial impact zone of the event based on the feature data; and
the machine learning model outputs in real-time data describing the estimated current spatial impact zone of the event;
electronically receiving, by at least one computer processor, data describing an actual spatial impact zone of the event as the event is occurring;
electronically saving, by at least one computer processor, the data describing the actual spatial impact zone with the feature data; and
electronically retraining, by at least one computer processor, the machine learning model on a batch basis with the data describing the actual spatial impact zone and the feature data.

2. The method of claim 1, further comprising:
electronically determining, by at least one computer processor, a probability that an asset is affected by the event based on the data describing the estimated current spatial impact zone of the event.

3. The method of claim 1, further comprising:
electronically determining, by at least one computer processor, whether to adjust output of the machine learning model, which represents the data describing the estimated current spatial impact zone of the event, based on whether the data describing the actual spatial impact zone at a time of the output is different from the data describing the estimated current spatial impact zone of the event.

4. The method of claim 1, wherein the electronic updates of the event at least include underlying data and written descriptions regarding the event.

5. The method of claim 4, wherein the gathering comprises:
fetching the underlying data;
performing natural language processing (NLP) analyses on the written descriptions; and
saving the underlying data and at least one result of the NLP analyses as the feature data.

6. The method of claim 1, wherein the feeding of the feature data is performed in response to an amount of the feature data gathered being equal to or greater than a predetermined threshold.

7. The method of claim 1, wherein the machine learning model is pre-trained with feature data of past events and corresponding data describing actual impact zones of past events.

8. A system, comprising:
one or more hardware computer processors configured with computer-executable instructions that, when executed, cause the one or more hardware computer processors to:
gather feature data from electronic updates of an event;
feed the feature data to a machine learning model;
cause the machine learning model to estimate in real-time a current spatial impact zone of the event based on the feature data;
cause the machine learning model to output in real-time data describing the estimated current spatial impact zone of the event;
receive data describing an actual spatial impact zone of the event as the event is occurring;
save the data describing the actual spatial impact zone with the feature data; and
retrain the machine learning model on a batch basis with the data describing the actual spatial impact zone and the feature data.

9. The system of claim 8, wherein the one or more hardware computer processors are configured with the computer-executable instructions that, when executed, further cause the one or more hardware computer processors to:
determine a probability that an asset is affected by the event based on the data describing the estimated current spatial impact zone of the event.

10. The system of claim 8, wherein the one or more hardware computer processors are configured with the computer-executable instructions that, when executed, further cause the one or more hardware computer processors to:
determine whether to adjust output of the machine learning model, which represents the data describing the estimated current spatial impact zone of the event, based on whether the data describing the actual spatial impact zone at a time of the output is different from the data describing the estimated current spatial impact zone of the event.

11. The system of claim 8, wherein the electronic updates of the event at least include underlying data and written descriptions regarding the event.

12. The system of claim 11, wherein the gathering of feature data comprises:
fetching the underlying data;
performing natural language processing (NLP) analyses on the written descriptions; and
saving the underlying data and at least one result of the NLP analyses as the feature data.

13. The system of claim 8, wherein the feeding of the feature data is performed in response to an amount of the feature data gathered being equal to or greater than a predetermined threshold.

14. The system of claim 8, wherein the machine learning model is pre-trained with feature data of past events and corresponding data describing actual impact zones of past events.

15. A non-transitory computer-readable storage medium with an executable program stored thereon, wherein the program instructs one or more processors to perform the following steps:
gather feature data from electronic updates of an event;
feed the feature data to a machine learning model;
cause the machine learning model to estimate in real-time the current spatial impact zone of the event based on the feature data;
cause the machine learning model to output in real-time data describing the estimated current spatial impact zone of the event;
receive data describing an actual spatial impact zone of the event as the event is occurring;
save the data describing the actual spatial impact zone with the feature data; and
retrain the machine learning model on a batch basis with the data describing the actual spatial impact zone and the feature data.

16. The non-transitory computer-readable storage medium of claim 15, wherein the program further instructs the one or more processors to perform the following step:
determine a probability that an asset is affected by the event based on the data describing the estimated current spatial impact zone of the event.

17. The non-transitory computer-readable storage medium of claim 15, wherein the program further instructs the one or more processors to perform the following step:
determine whether to adjust output of the machine learning model, which represents the data describing the estimated current spatial impact zone of the event, based on whether the data describing the actual spatial impact zone at a time of the output is different from the data describing the estimated current spatial impact zone of the event.

18. The non-transitory computer-readable storage medium of claim 15, wherein the electronic updates of the event are received as mobile geo-located data via one more mobile devices of users and at least include underlying data and written descriptions regarding the event.

19. The non-transitory computer-readable storage medium of claim 18, wherein the gathering of feature data comprises:
fetching the underlying data;
performing natural language processing (NLP) analyses on the written descriptions; and
saving the underlying data and at least one result of the NLP analyses as the feature data.

20. The non-transitory computer-readable storage medium of claim 15, wherein the feeding of the feature data is performed in response to an amount of the feature data gathered being equal to or greater than a predetermined threshold.

21. The non-transitory computer-readable storage medium of claim 15, wherein the machine learning model is pre-trained with feature data of past events and corresponding data describing actual impact zones of past events.
